(19) United States
(12) Patent Application Publication
(10) Pub. No.: US 2008/0233281 A1
(43) Pub. Date: Sep. 25, 2008

(54) PROCESS FOR PRODUCING AN OPTICAL ELEMENT

(75) Inventors: Yoshiko Kiyohara, Shinjuku-ku (JP); Runa Nakamura, Shinjuki-ku (JP); Naoya Ogata, Suginami-ku (JP)

Correspondence Address: HARNESS, DICKEY & PIERCE, P.L.C., P.O. BOX 828, BLOOMFIELD HILLS, MI, 48303, US

(73) Assignee: Dai Nippon Printing Co., Ltd., Shinjuku-ku (JP)

(21) Appl. No.: 12/111,675

(22) Filed: Apr. 29, 2008

Related U.S. Application Data
(62) Division of application No. 10/860,376, filed on Jun. 3, 2004.

(30) Foreign Application Priority Data
Dec. 12, 2002 (JP) 2002-361543
Dec. 11, 2003 (JP) 2003-413974

(51) Int. Cl. B05D 5/06

(52) U.S. Cl. 427/163.3

(57) ABSTRACT

A composition for an aligning film that may have significantly improved adhesion to an optical functional layer (a liquid crystal layer), may significantly improve the alignment of a liquid crystalline compound, and may have excellent durability. The composition for an aligning film is used in a process for producing an optical element which includes a plastic support and, providing on the surface of the plastic support in the following order, an aligning film, and at least one optical functional layer containing a liquid crystalline compound composition. The composition can include A) a nonionic water-soluble etherified polysaccharide and B) water and/or a lower alcohol solvent.

### CROSS-REFERENCE TO RELATED APPLICATIONS

The present application is a divisional of U.S. Ser. No. 10/860,376, filed Jun. 3, 2004. This related application is hereby incorporated herein in its entirety.

### BACKGROUND OF THE INVENTION

1. Field of the Invention

The present invention relates to a composition utilized in an aligning film for constituting a liquid crystalline optical element, and a production process of an optical element using the same.

2. Background Art

For liquid crystals, in addition to applications utilizing reversible motion of liquid crystal molecules, for example, display media such as display devices typified by TN type and STN type display devices, various applications utilizing alignment of liquid crystal and anisotropy derived from physical properties such as refractive index, permittivity, and magnetic susceptibility, for example, phase difference plates, deflection plates, light deflection prisms, and various optical filters have been studied.

In recent years, also for liquid crystal compounds per se, various structures have been developed including liquid crystalline polymers and polymerizable liquid crystals. For liquid crystalline polymers, ripening at a high temperature for a long period of time is necessary for alignment. Therefore, the productivity is very low, and liquid crystalline polymers are unsuitable for mass production. For this reason, in recent years, there is an increasing tendency toward the production of optical elements utilizing polymerizable liquid crystals having excellent productivity. Japanese Patent Laid-Open No. 142647/1999 and Published Japanese Translation of PCT Publication No. 533742/2002 propose polymerizable liquid crystal compounds for the production of optical elements. As an example of an optical element using a liquid crystal compound, Japanese Patent Laid-Open No. 215921/1993 proposes a phase difference plate comprising a glass support and a liquid crystal layer formed of a polymerizable rodlike compound having liquid crystallinity and positive birefringent index.

An aligning film in optical elements such as the above phase difference plate should function to specify alignment direction of liquid crystal compounds. For example, polymers such as polyimides, polyvinyl alcohol, and gelatin are known to have an aligning property, and it is known that an aligning film can be formed by forming a layer of the above polymer on a support and subjecting the polymer layer to aligning treatment such as rubbing treatment or conducting oblique vapor deposition of an inorganic compound to form an aligning film.

In recent optical elements, in many cases, a plastic film is used as a support, and an aligning film is formed on the support. Therefore, for polymers for the aligning film, the use of polymers, which requires high temperature at the time of film formation, should be avoided. Among polymers used for the aligning film, polyvinyl alcohol can form a film at a lower temperature than polyimides. Therefore, in recent years, polyvinyl alcohol has become used in aligning film formation.

However, when polyvinyl alcohol is used in an unmodified state, the adhesion to an optical functional layer formed of a liquid crystal compound is poor, and, hence, the optical functional layer is sometimes disadvantageously separated from the aligning film. Further, during use and storage under high temperature and high humidity conditions, netlike wrinkles are likely to occur in the optical functional layer (see Japanese Patent Laid-Open No. 62426/2002).

On the other hand, Japanese Patent Laid-Open No. 23843/1999 proposes a method in which the surface of triacetylcellulose or/and saponified triacetylylcellulose is directly rubbed to align and fix a liquid crystalline polymer. The claimed advantageous of this method is to reduce a failure of an optical element derived from poor durability of the aligning film. However, triacetylcellulose and saponified triacetylcellulose have low solvent resistance and are dissolved in solvents used in coating liquids of liquid crystalline compounds. Therefore, uneven aligning occurs, and, thus, satisfactory liquid crystal alignment cannot be realized. Further, the type of usable liquid crystalline compounds is disadvantageously limited.

Japanese Patent Laid-Open No. 152509/1997 proposes a method in which polyvinyl alcohol is modified before the formation of an aligning film. In this method, however, since a solvent used for the modification reaction of the polyvinyl alcohol has a high boiling point, a coating liquid containing the solvent cannot be used. Therefore, the step of reprecipitating polyvinyl alcohol for purification is indispensable, leading to increased production cost.

Japanese Patent Laid-Open No. 236216/2002 lists a large number of resins as an aligning film material for optical compensating film, and cellulosic plastics are also cited as an example thereof. This publication, however, does not refer to a technical problem of the adhesion between the aligning film and the optical functional layer (liquid crystal layer) and the selection of specific cellulosic plastic materials at all.

Japanese Patent Laid-Open No. 194668/1994 proposes the use of a modified polysaccharide as an aligning film for liquid crystal displays. In this case, however, a glass substrate is adopted as a support for aligning film formation, and this publication does not refer to the necessity of adopting a plastic film at all.

### SUMMARY OF THE INVENTION

The present inventor has found that the adoption of a composition, for an aligning film, containing a specific component can form an aligning film that has significantly improved adhesion to an optical functional layer (a liquid crystal layer) and alignment of a liquid crystalline compound and has excellent durability. The present invention has been made based on such finding. Accordingly, an object of the present invention is to provide an excellent composition for an aligning film and a low-cost production process of an optical element using the same.

According to a first aspect of the present invention,

there is provided a composition for an aligning film for use in the production of an optical element, said optical element comprising a plastic support and, provided on the surface of said plastic support in the following order, an aligning film, and at least one optical functional layer containing a liquid crystalline compound, said composition comprising:

A) a nonionic water-soluble etherified polysaccharide; and

B) water and/or a lower alcohol solvent.

According to a second aspect of the present invention,

there is provided a composition for an aligning film for use in the production of an optical element, said optical element comprising a plastic support and, provided on the surface of said plastic support in the following order, an aligning film, and an optical functional layer containing a liquid crystalline compound, said composition comprising:

A) a water-soluble polysaccharide;

B) water and/or a lower alcohol solvent; and

C) a monomer or oligomer having an ethylenically unsaturated bond.

According to a third aspect of the present invention, there is provided

a process for producing an optical element comprising a plastic support and, provided on said plastic support in the following order, an aligning film, and at least one optical functional layer containing a liquid crystalline compound, said process comprising the steps of:

forming, on the surface of said plastic support, said aligning film using the composition for an aligning film according to the first or second aspect of the present invention; and

forming said optical functional layer on the surface of said aligning film.

The composition for an aligning film according to the present invention can form an aligning film that has excellent adhesion to an optical functional layer and adhesion to a plastic support, and can easily align a liquid crystalline compound in the optical functional layer by the alignment control force of the aligning film. Therefore, an inexpensive highly durable luminescent element can be realized.

### BRIEF DESCRIPTION OF THE DRAWING

FIG. 1 is a cross-sectional view of the layer construction of the optical element according to the present invention.

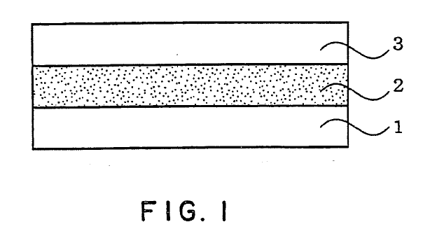

### DESCRIPTION OF REFERENCE CHARACTERS IN DRAWING

1: plastic support, 2: aligning film, and 3: optical functional layer.

### DETAILED DESCRIPTION OF THE INVENTION

First Aspect of Invention (Composition for Aligning Film)

A) Nonionic Water-Soluble Etherified Polysaccharide

The nonionic water-soluble etherified polysaccharide is a preferred component because the nonionic water-soluble etherified polysaccharide is high in transparency at the time of the formation of the aligning film and insoluble or sparingly soluble in organic solvents used in the formation of the optical functional layer. Further, the aligning film formed using this polysaccharide can enhance the adhesion to the optical functional layer. Furthermore, the aligning film has excellent adhesion to a plastic support (particularly cellulosic compound).

Specific examples of nonionic water-soluble etherified polysaccharides include methyl cellulose, hydroxyethyl cellulose, hydroxypropyl cellulose, hydroxyethylmethyl cellulose, hydroxypropylmethyl cellulose, and hydroxypropylstarch. Among them, hydroxyethyl cellulose and hydroxypropylmethyl cellulose are preferred.

Hydroxyethyl cellulose or hydroxypropylmethyl cellulose can enhance the adhesion of the aligning film formed using this cellulose-containing composition for an aligning film to the optical functional layer, independently of whether or not modification which will be described later has been carried out. When modification which will be described later has been carried out, the adhesion between the aligning film and the optical functional layer can be further improved.

Introduction of Ethylenically Unsaturated Bond

The nonionic water-soluble etherified polysaccharide is preferably one into which one or more ethylenically unsaturated bonds have been introduced. An aligning film using this modified polysaccharide has excellent adhesion to an optical functional layer formed of a liquid crystalline compound and can improve durability of the aligning film such as solvent resistance and heat resistance.

A specific example of a nonionic water-soluble etherified polysaccharide with an ethylenically unsaturated bond introduced thereinto is such that one or more hydroxyl groups contained in the nonionic water-soluble etherified polysaccharide are preferably substituted by groups represented by formulae (II) and (III):

-L²¹-(CH═CH)ₚ-A-O—(R²)_{q}-(L²²)ₛ-Q² (II)

wherein

L²¹ represents an ether bond, a urethane bond, an acetal bond, or an ester bond,

A represents an arylene group, or an arylene group substituted by a halogen, alkyl, alkoxy, or substituted alkoxy, wherein “the substituent in the substituted alkoxy” is alkoxy, aryl, halogen, vinyl, vinyloxy, acryloyl, methacryloyl, crotonoyl, acryloyloxy, methacryloyloxy, crotonoyloxy, vinylphenoxy, vinylbenzoyloxy, styryl, 1,2-epoxyethyl, 1,2-epoxypropyl, 2,3-epoxypropyl, 1,2-iminoethyl, 1,2-iminopropyl, or 2,3-iminopropyl,

R² represents an optionally substituted alkylene or alkyleneoxy group,

L²² represents a linking group for connecting R² to Q² and is preferably specifically represented by —O—, —S—, —CO—, —O—CO—, —CO—O—, —O—CO—O—, —CO—O—CO—, —NRCO—, —CONR—, —NR—, —NRCONR—, —NRCO—O—, or —OCONR— wherein R represents a hydrogen atom or a lower alkyl group,

Q² represents a vinyl group, and

p, q, and s each are 0 or 1; and

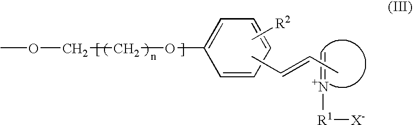

wherein formula (IV):

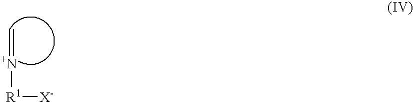

which is the functional group in formula (III) represents a quaternized aromatic nitrogen-containing heterocyclic ring group,

R¹ represents an alkylene group,

R² represents a hydrogen atom or a lower alkoxy group,

X⁻ represents SO₃⁻ or CO₂⁻,

m is 0 (zero) or 1, and

n is an integer of 1 to 6.

In a preferred embodiment of the present invention, one or more hydroxyl groups contained in the nonionic water-soluble etherified polysaccharide are substituted by a group represented by formula (I):

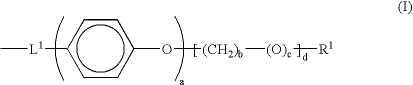

wherein

L¹ represents a group of atoms necessary for forming a urethane bond or an ester bond;

R¹ represents vinyl, acryloyl, methacryloyl, crotonoyl, or styryl;

a and c are each 0 (zero) or 1;

b is an integer of 2 to 24; and

d is an integer of 0 (zero) to 4.

The above specific polysaccharide can be produced by reacting an isocyanate compound, acid halide, mixed acid anhydride, or epoxy compound containing a group represented by formula (I) or (II) with a hydroxyl or carboxyl group in the polysaccharide. Specific examples of compounds include (meth)acryloyloxyalkyl isocyanate and glycidyl (meth)acrylate.

Solvents (reaction solvents) usable for dissolving the polysaccharide and the compound containing the above specific group include various solvents ranging from polar solvents to nonpolar solvents. Examples of such solvents include polar solvents such as N,N-dimethylformamide (DMF), dimethyl sulfoxide (DMSO), N,N-dimethylacetamide, and pyridine, ethers such as tetrahydrofuran and 1,2-dimethoxyethane, ketones such as methyl ethyl ketone and methyl isobutyl ketone, halogenated hydrocarbons such as dichloromethane and chloroform, and nonpolar solvents such as benzene and hexane. They may be used either solely or in a combination of two or more.

If necessary, a catalyst may be used for the reaction. Any of an organic or inorganic catalysts may be used as a basic catalyst used in esterification with a mixed acid anhydride and an acid halide. Specific examples of such catalysts include hydroxides (for example, sodium hydroxide, potassium hydroxide, and ammonium hydroxide), alkoxides (for example, sodium methoxide, sodium ethoxide, and potassium t-butoxide), metal hydrides (for example, sodium hydride and calcium hydride), amines (for example, pyridine, triethylamine, piperidine, and 1,8-diazabicyclo[5,4,0]-7-undecene (DBU)), carbonates (for example, sodium carbonate, potassium carbonate, and sodium hydrogencarbonate), and acetates (for example, sodium acetate and potassium acetate). Amines are particularly preferred, and they may be used as a solvent.

Specific examples of catalysts usable for the urethanation with an isocyanate include alkoxides (for example, sodium methoxide, sodium ethoxide, and potassium t-butoxide), metallic compounds (for example, di-n-butyltin dilaurate, tin octoate, and zinc acetylacetonate), amines (for example, pyridine, triethylamine, piperidine, and 1,8-diazabicyclo[5,4,0]-7-undecene (DBU), tetramethylbutanediamine (TMBDA), and 1,4-diaza[2,2,2]bicyclooctane (DABCO)).

B) Water and/or Lower Alcohol Solvent

The solvent contained in the composition for an aligning film according to the present invention is a water/lower alcohol solvent. The term “water/lower alcohol solvent” as used herein refers to a solvent which is composed mainly of water and/or a lower alcohol with the total content of water and the lower alcohol being 70% by mass to 100% by mass. This solvent may contain solvents exemplified by ketone, ether, ester or other solvents so far as they are compatible with water and the lower alcohol and the content thereof is less than 30% by mass.

In the present invention, the solvent is particularly preferably a lower alcohol (methanol or ethanol) having a defoaming function, or a mixed solvent composed of water and the lower alcohol. The mass ratio between water and the lower alcohol is preferably water:lower alcohol=0:100 to 90:10. This can suppress the foaming at the time of coating and can significantly reduce surface defects of the aligning film and, further, the optical functional layer.

Optional Components (Photopolymerization Initiator)

If necessary, the composition for an aligning film according to the present invention may contain optional components. For example, a photopolymerization initiator may be added. The photopolymerization initiator may be any one so far as it is dissolved in a water/lower alcohol solvent, and examples thereof include Irgacure 651, Irgacure 184, Irgacure 2959, Irgacure 1800, and Irgacure 1850 (tradenames, manufactured by Ciba Specialty Chemicals, K.K.).

Second Aspect of Invention (Composition for Aligning Film)

A) Water-Soluble Polysaccharide

The water-soluble polysaccharide functions as a component for imparting a liquid crystal aligning property in the composition for an aligning film.

Specific examples of water-soluble polysaccharides include water-soluble cellulose (for example, methyl cellulose, hydroxyethyl cellulose, hydroxypropyl cellulose, hydroxyethylmethyl cellulose, hydroxypropylmethyl cellulose, carboxymethylcellulose sodium salt, and carboxylmethyl cellulose ammonium salt), starch, hydroxypropyl starch, carboxymethyl starch, pullulan, chitosan, and cyclodextrin. Among them, hydroxyethyl cellulose and hydroxypropylmethyl cellulose are preferred.

Hydroxyethyl cellulose or hydroxypropylmethyl cellulose can enhance the adhesion of the aligning film formed using this cellulose-containing composition for an aligning film to the optical functional layer, independently of whether or not the above modification has been carried out. When the above modification has been carried out, the adhesion between the aligning film and the optical functional layer can be further improved.

C) Monomer or Oligomer Containing Ethylenically Unsaturated Bond

When a composition for an aligning film prepared by adding one or more monomers or oligomers containing an ethylenically unsaturated bond to the polysaccharide is used for the formation of a coating film, the coating film can be cured by exposure to ultraviolet light or electron beams. The cured aligning film can supplement properties, which lack in the polysaccharide, that is, a property, which enhances adhesion to the optical functional layer, and heat resistance and solvent resistance by a necessary level.

The ethylenically unsaturated bond-containing monomer or oligomer may be any one so far as it is soluble in water and/or the lower alcohol solvent, and the number of ethylenically unsaturated bonds in the molecule may be one or plural.

Specific examples of monomers or oligomers containing one ethylenically unsaturated bond in their molecule include heterocyclic ring-containing monomers [for example, N-vinylpyrrolidone, N-(meth)acryloyl morpholine, and N-((meth)acryloyloxyethyl)morpholine], acryl amide monomers [for example, (meth)acrylamide, N-alkyl(1 to 4 carbon atoms)-substituted, hydroxyalkyl(1 to 4 carbon atoms)-substituted, or alkoxy(1 to 4 carbon atoms)alkyl(1 to 5 carbon atoms)-substituted (meth)acrylamide, and N,N-dialkyl(1 to 5 carbon atoms)-substituted (meth)acrylamides, for example, N-methyl (meth)acrylamide, N-ethyl (meth)acrylamide, N-isopropyl (meth)acrylamide, N,N-dimethyl (meth)acrylamide, N,N-diethyl (meth)acrylamide, N-methylol (meth)acrylamide, N-methoxymethyl (meth)acrylamide, N-ethoxymethyl (meth)acrylamide, and N-butoxymethyl (meth)acrylamide; diacetone (meth)acrylamide; N,N-dialkyl (1 to 5 carbon atoms)aminoalkyl(2 to 5 carbon atoms) (meth)acrylamides, for example, N,N-dimethylaminoethyl (meth)acrylamide, N,N-diethylaminoethyl (meth)acrylamide, N,N-dimethylaminopropyl (meth)acrylamide, and N,N-diethylaminopropyl (meth)acrylamide], acrylate monomers [hydroxyl-containing (meth)acrylic esters (hydroxyalkyl(1 to 5 carbon atoms) (meth)acrylate, for example, hydroxymethyl (meth)acrylate, 2-hydroxyethyl (meth)acrylate, and 2-hydroxypropyl (meth)acrylate; mono(meth)acrylates of tri- to octavalent or higher polyhydric alcohols, for example, glycerol mono(meth)acrylate; mono(meth)acrylates of polyalkylene glycols (degree of polymerization: 2 to 300 or more, and number of carbons in the alkylene group: 2 to 4), for example, polyethylene glycol mono(meth)acrylate), and lower alkyl(1 to 4 carbon atoms) ethers thereof (for example, 2-ethoxyethyl (meth)acrylate, 2-ethoxypropyl (meth)acrylate, and Carbitol (meth)acrylate) and the like], carboxylic acid group-containing monomers [for example, (meth)acrylic acid], sulfonic acid group-containing monomers [for example, 3-sulfopropyl (meth)acrylate and 2-acryloylamino-2-methylpropane sulfonic acid], phosphoric acid group-containing monomers [for example, phosphoric esters of the above hydroxyl-containing (meth)acrylic esters, for example, 2-(meth)acryloyl oxyethyl phosphate], quaternary ammonium salt group-containing monomers [(meth)acryloyl oxyalkyl (2 or 3 carbon atoms) trialkyl (1 to 3 carbon atoms) ammonium salts, for example, 2-(meth)acryloyl oxyethyl trimethyl ammonium chloride; (meth)acrylamide alkyl (1 or 2 carbon atoms) trialkyl (1 to 3 carbon atoms) ammonium salts, for example, (meth)acrylamide methyl trimethyl ammonium chloride; vinylbenzyl trialkyl ammonium salts, for example, vinylbenzyl trimethyl ammonium chloride], (meth)acryloyloxyalkyltrialkoxysilanes [for example, (meth)acryloyloxypropyltrimethoxysilane and (meth)acryloyloxypropyltriethoxysilane], and (meth)acryloyloxyalkylalkyl-dialkoxysilanes [for example, (meth)acryloyloxypropylmethyldimethoxy-silane and (meth)acryloyloxypropylmethyldiethoxysilane] and the like. They may be used either solely or in a combination of two or more.

Monomers or oligomers having a plurality of ethylenically unsaturated bonds in their molecule can be satisfactorily crosslinked in the course of curing of the aligning film upon exposure to ultraviolet light or electron beams to form a network matrix which can advantageously improve heat resistance and solvent resistance. Examples of monomers or oligomers having a plurality of ethylenically unsaturated bonds in their molecule include polyethylene glycol di(meth)acrylate, ethylene oxide-modified bisphenol A di(meth)acrylate, ethylene oxide-modified trimethylolpropane tri(meth)acrylate, ethylene oxide-modified pentaerythritol tetra(meth)acrylate, ethylene oxide-modified dipentaerythritol hexa(meth)acrylate, and epoxy (meth)acrylates prepared by adding (meth)acrylic acid to a di- or polyepoxy compound.

When the material for forming the optical functional layer is an ethylenically unsaturated bond-containing liquid crystal compound which is a polymerizable liquid crystal compound, the crosslinked polysaccharide formed in the course of curing of the ethylenically unsaturated bond-containing monomer or oligomer in the aligning film or of the aligning film can enhance affinity at the interface of the aligning film and the optical functional layer to enhance the adhesion between the aligning film and the optical functional layer.

Components other than the above components A) and C) may be the same as those described above in connection with the composition for an aligning film according to the first aspect of the present invention.

Third Aspect of Invention (Production Process of Light Emitting Element)

According to the third aspect of the present invention, there is provided a production process of a light emitting element which comprising stacking a plastic support, an aligning film, and an optical functional layer formed of a liquid crystalline compound in that order. This production process is realized by the following steps.

1. Formation of Aligning Film

In the present invention, a preferred method for forming an aligning film includes 1) the step of coating the composition for an aligning film according to the first or second aspect of the present invention onto a plastic support, and 2) the step of optionally rubbing the formed coating film.

Whether or not curing of the coating film by exposure to ultraviolet light or electron beams is necessary may be properly determined by the type of the polymer in the composition for an aligning film and the type and amount of a monomer or oligomer containing an ethylenically unsaturated bond. For example, the amount of the monomer or oligomer containing an ethylenically unsaturated bond added is small and the purpose of adding the monomer or oligomer is only to improve the adhesion between the optical functional layer and the aligning film, there is no need to apply ultraviolet light or electron beams to the coating film. However, when the glass transition temperature of the polymer is low and when the amount of the monomer or oligomer containing an ethylenically unsaturated bond added is large, the coating film should be cured by applying ultraviolet light or electron beams to the coating film. This curing can impart solvent resistance, heat resistance, moisture resistance and the like to the aligning film. The application of ultraviolet light or electron beams can satisfactorily suppress bleedout of the monomer containing the ethylenically unsaturated bond onto the surface of the coating film.

When rubbing is carried out, the step of applying ultraviolet light or electron beams may be carried out before or after rubbing of a coating film formed by coating the composition for an aligning film according to the present invention onto a plastic support and drying the coating.

When the amount of the monomer or oligomer containing an ethylenically unsaturated bond added is large, the surface of a coating film formed by coating the composition for an aligning film onto a plastic support and drying the coating is tacky. Therefore, in this case, the application of ultraviolet light or electron beams is preferably carried out before rubbing. When the amount of the monomer or oligomer containing an ethylenically unsaturated bond added is small, the step of applying ultraviolet light or electron beams may be provided either before or after rubbing.

Means for Coating of Aligning Film

Methods usable for coating the composition for an aligning film described above in connection with the first or second aspect of the present invention onto the plastic support include spin coating, roll coating, dip coating, curtain coating, extrusion coating, bar coating, and E type coating. Next, the coating is irradiated with ultraviolet light or electron beams to cure the coating, and the resultant coating film is then rubbed to provide an aligning film having an aligning regulating capability. The thickness of the aligning film thus formed is preferably in the range of 0.1 to 10 μm. After the composition for an aligning film is coated, the coating is dried to remove the solvent. Methods usable in this case include, for example, vacuum drying or heat drying, and a combination of these methods. The temperature for heat drying is preferably in the range of 20 to 120° C.

In another embodiment of the production process of an optical element according to the present invention, the coating film formed by coating according to the above method is rubbed, followed by exposure to ultraviolet light or electron beams to cure the coating, thereby forming an aligning film having an alignment regulating capability.

2. Formation of Optical Functional Layer

An optical functional layer is formed by coating a solution, prepared by dissolving a liquid crystalline polymer and other compounds in a solvent, onto the aligning film, drying the coating, then heating the dried coating to a liquid crystal phase forming temperature, and then cooling the heated coating while maintaining the aligned state, whereby an optical element is provided. Alternatively, an optical functional layer may be formed by coating a solution, prepared by dissolving a polymerizable liquid crystal compound and other compounds (further, for example, a polymerizable monomer and a photopolymerization initiator) in a solvent, onto the aligning film, drying the coating, then heating the dried coating to a liquid crystal phase forming temperature, then applying UV or electron beams to the coating to cause polymerization, and further cooling the exposed coating, whereby an optical element is provided. In the optical element according to the present invention, the optical functional layer may have a single layer structure or two or more layer structure.

Optical Element

According to the first to third aspects of the present invention, an optical element having the following construction is provided.

1. Plastic Support

The type of the plastic support may be determined depending upon applications of the optical element (a laminate of a plastic support, an aligning film, and an optical functional layer). When the optical element is used as optical compensation sheets such as phase difference plates, polarizers, and color filters for displays, a transparent polymer film is used as the plastic support. The term “transparent” means that the light transmittance is not less than 80%.

Examples of materials for the transparent polymer film include norbornene polymers such as cellulosic polymers, ARTON (tradename; manufactured by JSR Corporation), cycloolefin polymers such as ZEONOR (tradename; manufactured by Nippon Zeon Co., Ltd.), and polymethyl methacrylate.

Cellulosic polymers (preferably surface saponified products thereof) are suitably used as the plastic support in the present invention, because they have affinity for water-soluble polysaccharides and are advantageous in adhesion. Cellulosic polymers include cellulose esters. Among them, lower fatty acid esters of cellulose are suitable. The term “lower fatty acid” means a fatty acid having 6 or less carbon atoms. The number of carbon atoms is preferably 2 (cellulose acetate), 3 (cellulose propionate), or 4 (cellulose butyrate). Cellulose acetate is preferred as the cellulose ester, and examples thereof include diacetyl cellulose and triacetyl cellulose. Further, mixed fatty acid esters such as cellulose acetate propionate or cellulose acetate butyrate may also be used.

When optical isotropy is required of the optical element, glass or cellulose ester is generally used as the plastic support. When optical anisotropy is required of the optical element, synthetic polymers (for example, polycarbonate, polysulfone, polyethersulfone, polyacrylate, polymethacrylate, norbornene resin, and polyester) are generally used. The optical anisotropy can be provided by stretching the synthetic polymer film.

The cellulose ester or synthetic polymer film as the plastic support is preferably formed by a solvent casting method. The thickness of the plastic support in the phase difference plate is preferably 20 μm to 500 μm, more preferably 40 μm to 200 μm.

In the phase difference plate, in order to improve the adhesion between the plastic support and the layer overlying the plastic support (aligning film, optical functional layer), the transparent plastic support may be subjected to surface treatment (for example, saponification treatment, grow discharge treatment, corona discharge treatment, ultraviolet (UV) treatment, or flame treatment). Further, a primer layer (an adhesive layer) may be formed.

2. Optical Functional Layer

The optical element according to the present invention has a structure comprising a plastic support, an aligning film provided on the plastic support, and an optical functional layer provided on the aligning film. A nematic liquid crystal or a cholesteric liquid crystal may be used as the optical functional layer. Regarding materials for the optical functional layer, when the optical functional layer is formed of these materials alone, any liquid crystal material, which can form a liquid crystal having nematic regularity, smectic regularity, or cholesteric regularity, is usable without particular limitation, and any of polymer liquid crystal and polymerizable liquid crystal compound may be used. Further, the optical functional layer may comprise two or more different liquid crystal layers. In this case, the plurality of layers are an identical liquid crystal layer, or alternatively may be liquid crystal layers of different types selected from nematic regularity, smectic regularity, or cholesteric regularity.

Polymerizable Liquid Crystal Compound

The polymerizable liquid crystal compound preferably has a polymerizable functional group at both ends of the molecule from the viewpoint of the production of an optical element having good heat resistance. Two or more optical functional layers may be stacked on top of each other.

Examples of the above polymerizable liquid crystal compound are those represented by formula (V) or mixtures of two or more:

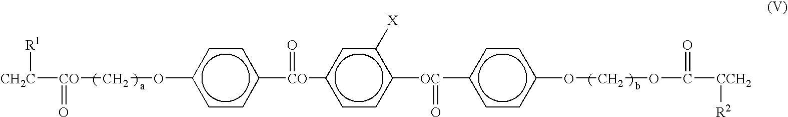

wherein

R¹ and R² each represent hydrogen or a methyl group and each are preferably hydrogen from the viewpoint of a wide temperature range in which a liquid crystal phase is developed;

X may be any of hydrogen, chlorine, bromine, iodine, an alkyl group having 1 to 4 carbon atoms, a methoxy group, a cyano group, or a nitro group and is preferably chlorine or a methyl group; and

a and b show the chain length of the alkylene group as a spacer of the (meth)acryloyloxy group at both ends of the molecular chain and the aromatic ring in the formula, may each independently be any integer in the range of 2 to 12 and are preferably in the range of 4 to 10, more preferably in the range of 6 to 10.

When a and b are in the above-defined range, the polymerizable liquid crystal compound has high stability, and is less likely to cause hydrolysis. Further, in this case, the crystallinity of the compound per se is high. Further, advantageously, the isotropic transition temperature (TI) is so high that the temperature range, in which liquid crystallinity is developed, is wide.

Further, the following compounds may be mentioned as the polymerizable liquid crystal compound.

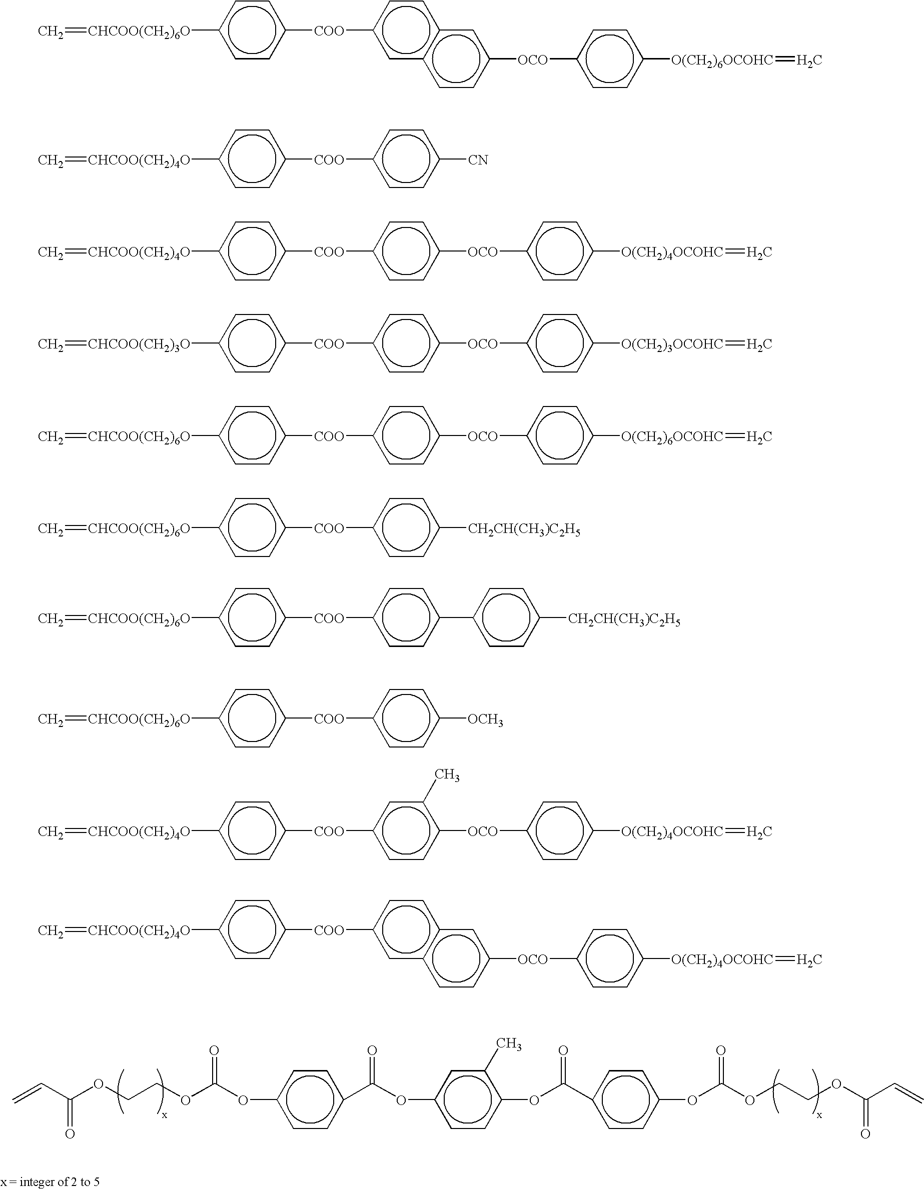

In the present invention, in addition to the above compounds, for example, polymerizable liquid crystal oligomers or polymerizable liquid crystal polymers may also be used. Conventional polymerizable liquid crystal oligomers or polymerizable liquid crystal polymers may be properly selected and used.

Chiral Agent

In the present invention, a chiral nematic liquid crystal having cholesteric regularity prepared by adding a (polymerizable) chiral agent to a nematic liquid crystal may be suitably used.

The chiral agent refers to a low-molecular compound which has an optically active site and a molecular weight of not more than 1,500. The chiral agent is mainly used for inducing a helical pitch in positive uniaxial nematic regularity developed by the compound of formula (V). So far as this object can be attained, any low-molecular compound may be used as the chiral agent without particular limitation. Specifically, any low-molecular compound may be used so far as the compound is compatible in a solution or melted state with the compound of formula (V), does not sacrifice the liquid crystallinity of the polymerizable liquid crystal compound, which can have nematic regularity, and can induce a desired helical pitch in the nematic regularity. The presence of a polymerizable functional group at both ends of the molecule is preferred from the viewpoint of providing highly heat resistant optical element.

For the chiral agent used for inducing a helical pitch in the liquid crystal, any chirality should be found at least in the molecule. Therefore, chiral agents usable in the present invention include, for example, compounds having one or at least two asymmetric carbon atoms, compounds having an asymmetric point on a hetero-atom such as chiral amines and chiral sulfoxides, or compounds having axial asymmetry such as cumulene and binaphthol. Further, specifically, commercially available chiral nematic liquid crystals, for example, S-811 (tradename) manufactured by Merck & Co. Inc. and the like may be mentioned.

Depending upon the properties of the selected chiral agent, however, the breaking of the nematic regularity formed by the compound of formula (V) or lowering in alignment occurs. When the compound is nonpolymerizable, there is a fear of a lowering in curability of the liquid crystal composition and a lowering in reliability of the cured film. Further, when the amount of the chiral agent having an optically active site used is large, the cost of the composition is disadvantageously increased. Therefore, when a circularly polarized light controlling optical element having short-pitch cholesteric regularity is produced, a chiral agent having a large helical pitch inducing effect is preferably selected as the chiral agent having an optically active site to be incorporated into the liquid crystal composition. Specifically, the use of a low-molecular compound having axial asymmetry in its molecule represented by formula (VI), (VII), or (VIII) is preferred:

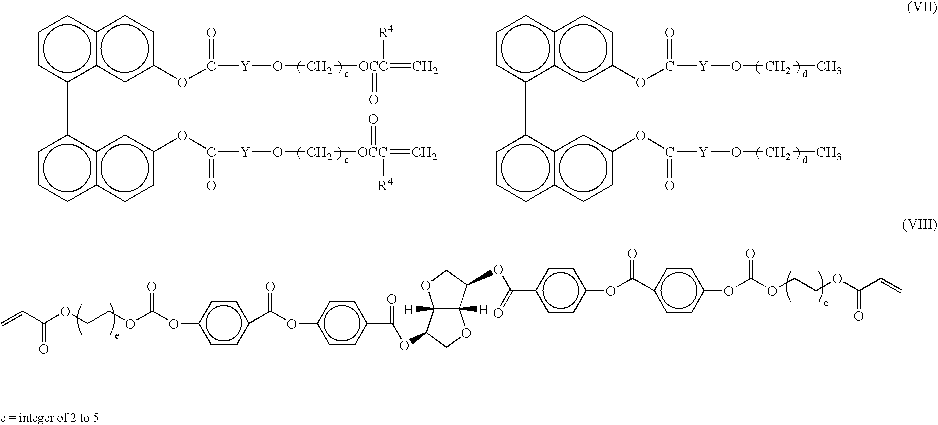

wherein

R⁴ represents hydrogen or a methyl group; and

c and d are the chain length of the alkylene group and are each independently any integer in the range of 2 to 12, preferably in the range of 4 to 10, more preferably in the range of 6 to 10. When c or d is in the above-defined range, the compound represented by formula (VI) or (VII) is stable, is less likely to cause hydrolysis, has a high level of crystallinity, and has a preferred melting point (Tm). This compound has improved compatibility with the compound of formula (V), which develops liquid crystallinity, and can suppress phase separation or the like.

Y is a group represented by any one of formulae (i) to (xxiv):

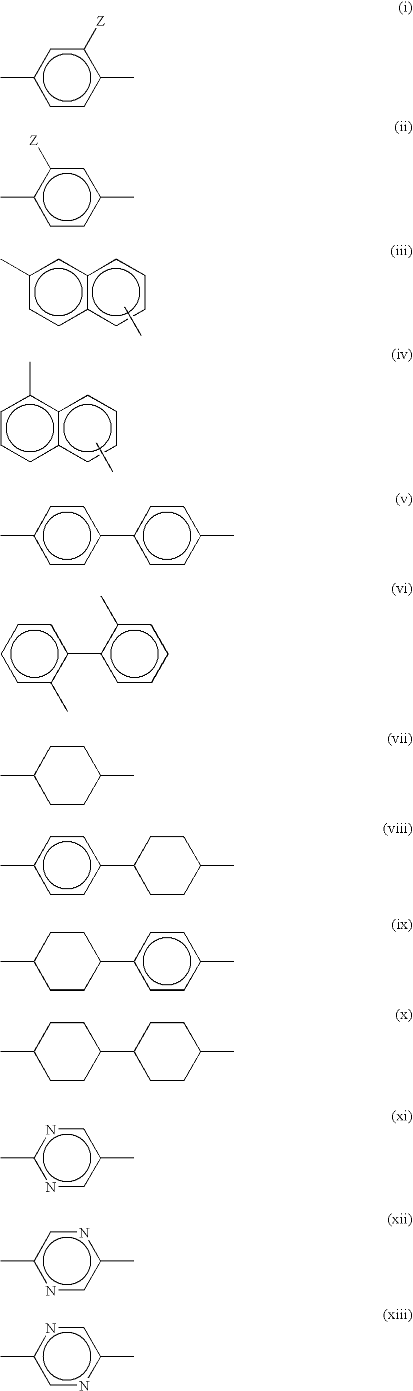

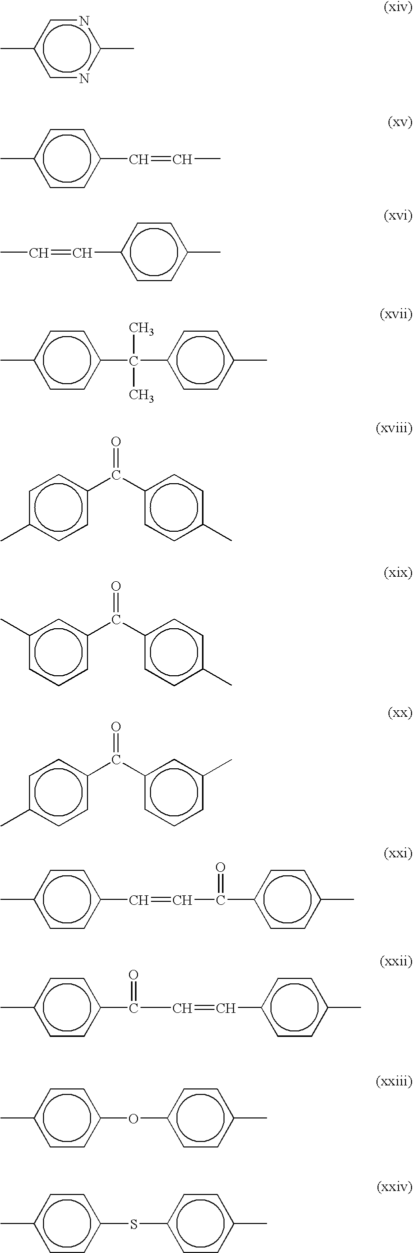

and is preferably a group represented by any one of formulae (i), (ii), (iii), (v) and (vii).

The optimal amount of the chiral agent incorporated in the polymerizable liquid crystal compound according to the present invention is determined by taking into consideration the helical pitch inducing ability and the cholesteric nature of the finally obtained optical element. Specifically, although the amount of the chiral agent incorporated significantly varies depending upon the polymerizable liquid crystal compound used, the amount of the chiral agent may be in the range of 0.01 to 60 parts by mass, most preferably 1 to 20 parts by mass, based on 100 parts by mass in total of the polymerizable liquid crystal compound. In the case of a chiral agent amount in the above-defined range, the alignment of the molecules is stable, no problem occurs at the time of curing by an actinic radiation, and satisfactory cholesteric properties can be imparted.

In the present invention, the chiral agent is not particularly necessarily polymerizable. When the heat stability and the like of the optical functional layer are taken into consideration, however, the use of a polymerizable chiral agent, which can be polymerized with the polymerizable liquid crystal compound to anchor the cholesteric regularity, is preferred. In particular, the presence of a polymerizable functional group at both ends of the molecule is preferred from the viewpoint of providing highly heat resistant optical elements.

Polymerization Initiator

Photopolymerization initiators added to the polymerizable liquid crystal compound include benzyl, benzoinisobutyl ether, benzoinisopropyl ether, benzophenone, benzoylbenzoic acid, methyl benzoylbenzoate, 4-benzoyl-4′-methyldiphenylsulfide, benzyl methyl ketal, dimethyl aminomethylbenzoate, 2-n-butoxyethyl-4-dimethyl aminobenzoate, isoamyl p-dimethylaminobenzoate, 3,3′-dimethyl-4-methoxybenzophenone, methylbenzoyl formate, 2-methyl-1-(4-(methylthio)phenyl)-2-morpholinopropan-1-one, 2-benzyl-2-dimethylamino-1-(4-morpholinophenyl)-butan-1-one, 1-(4-dodecylphenyl)-2-hydroxy-2-methylpropan-1-one, 1-hydroxycyclohexyl phenyl ketone, 2-hydroxy-2-methyl-1-phenylpropan-1-one, 1-(4-isopropylphenyl)-2-hydroxy-2-methylpropan-1-one, 2-chlorothioxanthone, 2,4-diethylthioxanthone, 2,4-diisopropylthioxanthone, 2,4-dimethylthioxanthone, isopropylthioxanthone, and 1-chloro-4-propoxythioxanthone. In addition to the photopolymerization initiator, a sensitizer may be added in such an amount range that is not detrimental to the object of the present invention.

The amount of the photopolymerization initiator added to the polymerizable liquid crystal compound is generally 0.01 to 20% by mass, preferably 0.1 to 10% by mass, more preferably 0.5 to 5% by mass.

Optional Components

The coating liquid for forming the optical functional layer may contain, in addition to the liquid crystalline compound, the chiral agent, and the photopolymerization initiator, optional components such as surfactants, polymerizable monomers (for example, compounds containing a vinyl, vinyloxy, acryloyl, and methacryloyl groups), and polymers so far as they are not detrimental to the alignment of the liquid crystalline compound. The selection of the surfactant, the polymerizable monomer, and the polymer can regulate the tilt angle of the liquid crystal on the surface side (air side).

Any solvent may be used for the coating liquid for optical functional layer formation without particular limitation so far as it can dissolve the liquid crystalline compound and the chiral agent and is not detrimental to the aligning property on the substrate having an aligning capability. Specific examples of solvents usable herein include hydrocarbons (for example, benzene, toluene, and hexane), ketones (for example, methy ethyl ketone, methyl isobutyl ketone, and cyclohexanone), ethers (for example, tetrahydrofuran and 1,2-dimethoxyethane), alkyl halides (for example, chloroform and dichloromethane), esters (for example, methyl acetate, butyl acetate, and propylene glycol monomethyl ether acetate), amides (for example, N,N-dimethylformamide), and sulfoxides (for example, dimethyl sulfoxide).

Formation of Optical Functional Layer

In the case of a liquid crystalline polymer, the optical functional layer may be formed by coating a solution, prepared by dissolving a liquid crystalline polymer and other compounds in a solvent, onto an aligning film, drying the coating, then heating the dried coating to a liquid crystal phase forming temperature, and then cooling the heated coating while maintaining the aligned state. Alternatively, the optical functional layer may be formed by coating a solution, prepared by dissolving a polymerizable liquid crystal compound and optional compounds (further, for example, a polymerizable monomer and a photopolymerization initiator) in a solvent onto an aligning film, drying the coating, then heating the dried coating to a liquid crystal phase forming temperature, then applying UV or electron beams to the heated coating for polymerization, and then cooling the exposed coating.

Use of Light Emitting Element Produced by Production Process of Invention

The optical element can be utilized, for example, as phase difference plates, polarizers, and color filters for displays.

The aligning film can be used, for example, for phase difference plates, polarizers, and color filters for displays.

### EXAMPLES

### Example 1

### Formation of Aligning Film

A composition for an aligning film having the following composition was coated by a wire bar coater onto a saponified triacetylcellulose film. The coated triacetylcellulose film was then dried by warm air of 80° C. for 10 min to form a 0.8 μm-thick coating film. The surface of the coating film was subjected to rubbing treatment to prepare an aligning film.

Composition for Aligning Film

| | | |
|---|---|---|
| Hydroxyethylcellulose (HEC Daicel SP200: | 2 | parts by mass |
| tradename, manufactured by Daicel | | |
| Chemical Industries, Ltd.) | | |
| Water | 72 | parts by mass |
| Methanol | 8 | parts by mass |

Formation of Nematic Liquid Crystal Layer

A polymerizable liquid crystalline compound represented by formula (IX):

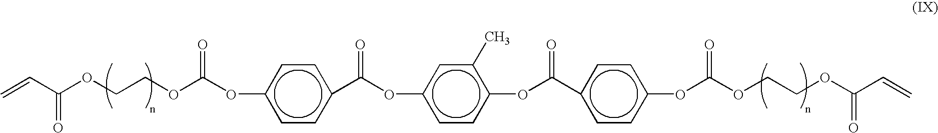

wherein n is an integer of 2 to 5

was dissolved in toluene to a concentration of 35% by mass. Further, a polymerization initiator (Irgacure 907: tradename, manufactured by Ciba Specialty Chemicals, K.K.) was added to the solution to prepare a solution for a liquid crystal composition for optical element formation. The solution for a liquid crystal composition was coated by a wire bar on the aligning film prepared in the above step, and the coating was dried and then heated at 85° C. for one min to align liquid crystal molecules. The alignment of the liquid crystal molecules could be confirmed by the fact that the film surface became transparent. While maintaining the aligned state, the optical functional layer was exposed to ultraviolet light of 50 mJ/cm² with a high pressure mercury lamp to cure the optical functional layer, thereby forming a nematic liquid crystal layer.

### Example 2

### Formation of Aligning Film

An aligning film was prepared in the same manner as in Example 1.

Formation of Cholesteric Layer

A polymerizable liquid crystalline compound represented by formula (X):

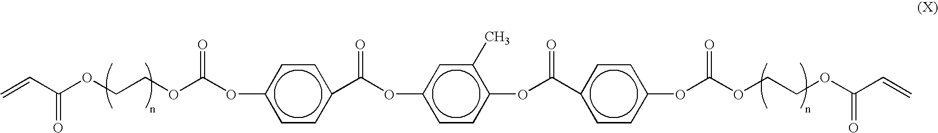

wherein n is an integer of 2 to 5

was dissolved in toluene to a concentration of 35% by mass. Further, a polymerizable compound represented by formula (XI):

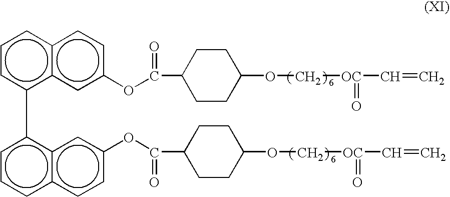

and a polymerization initiator (Irgacure 907: tradename, manufactured by Ciba Specialty Chemicals, K.K.) were added to the solution to prepare a solution for a liquid crystal composition for optical element formation.

The solution for a liquid crystal composition was coated by a wire bar on the aligning film, and the coating was dried and then heated at 85° C. for one min to align liquid crystal molecules. The alignment of the liquid crystal molecules could be confirmed by the fact that the film surface became transparent. While maintaining the aligned state, the liquid crystal layer was exposed to ultraviolet light of 50 mJ/cm² with a high pressure mercury lamp to cure the liquid crystal layer, thereby forming a layer (an optical functional layer) formed of cholesteric liquid crystal.

### Example 3

### Formation of Aligning Film

A composition for an aligning film having the following composition was coated by a wire bar coater onto a saponified triacetylcellulose. The coated triacetylcellulose was then dried by warm air of 80° C. for 10 min to form a 0.8 μm-thick coating film. Composition for aligning film

| | | |
|---|---|---|
| Hydroxyethylcellulose (HEC Daicel SP200: | 2 | parts by mass |
| tradename, manufactured by Daicel | | |
| Chemical Industries, Ltd.) | | |
| Water | 72 | parts by mass |
| Methanol | 8 | parts by mass |

Preparation of Cholesteric Liquid Crystal Layer

A cholesteric liquid crystal layer was formed on the aligning film formed in the above step in the same manner as in Example 2.

### Example 4

An aligning film and a cholesteric liquid crystal layer were formed in the same manner as in Example 2, except that hydroxyethylcelulose was changed to 2 parts by mass of hydroxypropylmethylcellulose (Metlose 60 SH-15: tradename, manufactured by The Shin-Etsu Chemical Co., Ltd.).

### Example 5

### Formation of Aligning Film

A composition for an aligning film having the following composition was coated by a wire bar coater onto a saponified triacetylcellulose film. The coated triacetylcellulose film was then dried by warm air of 80° C. for 10 min to form a 0.8 μm-thick coating film. The coating film was exposed to ultraviolet light at 50 mJ/cm² with a high pressure mercury lamp, and the surface of the exposed coating film was then subjected to rubbing treatment to form an aligning film.

Composition for Aligning Film

| | | |
|---|---|---|
| Hydroxyethylcellulose (HEC Daicel SP200: | 2 | parts by mass |
| tradename, manufactured by Daicel | | |
| Chemical Industries, Ltd.) | | |
| Ethylene oxide-modified trimethylol | 0.1 | part by mass |
| propane triacrylate (SR-9035: tradename, | | |
| manufactured by Nippon Kayaku Co., Ltd.) | | |
| Polymerization initiator (Irgacure 2959: | 0.01 | part by mass |
| manufactured by Ciba Specialty | | |
| Chemicals, K.K.) | | |
| Water | 72 | parts by mass |
| Methanol | 8 | parts by mass |

Preparation of Cholesteric Liquid Crystal Layer

A cholesteric liquid crystal layer was formed on the aligning film formed in the above step in the same manner as in Example 2.

### Example 6

### Formation of Aligning Film

An aligning film was prepared in the same manner as in Example 5, except that the composition for an aligning film was changed to the following composition.

Composition for Aligning Film

| | | |
|---|---|---|
| Hydroxypropylmethylcellulose (Metlose 60 | 1.4 | parts by mass |
| SH-15: tradename, manufactured by The | | |
| Shin-Etsu Chemical Co., Ltd.) | | |
| Polyethylene glycol diacrylate (Aronix M-245: | 0.6 | part by mass |
| tradename, manufactured by Toa Gosei | | |
| Chemical Industry Co., Ltd.) | | |
| Polymerization initiator (Irgacure 2959: | 0.04 | part by mass |
| manufactured by Ciba Specialty | | |
| Chemicals, K.K.) | | |
| Water | 72 | parts by mass |
| Methanol | 8 | parts by mass |

Preparation of Nematic Liquid Crystal Layer

A nematic liquid crystal layer was formed on the aligning film formed in the above step in the same manner as in Example 1.

### Example 7

An aligning film and a cholesteric liquid crystal layer were formed in the same manner as in Example 3, except that hydroxyethylcelulose was changed to hydroxyethylcellulose with an acryloyl group introduced thereinto (amount of acryloyl group introduced: 0.1 mmol/g).

### Example 8

A cholesteric liquid crystal layer was formed on the nematic liquid crystal layer of the optical element prepared in Example 6 in the same manner as in Example 2.

### Comparative Example 1

An aligning film and a nematic liquid crystal layer were formed in the same manner as in Example 1, except that hydroxyethylcellulose was changed to polyvinyl alcohol (NM-11: tradename, manufactured by The Nippon Synthetic Chemical Industry Co., Ltd.) having a degree of saponification of 99%.

### Comparative Example 2

An aligning film and a nematic liquid crystal layer were formed in the same manner as in Example 1, except that hydroxyethylcellulose was changed to carboxymethylcellulose ammonium salt (CMC DAICEL <AMMONIUM> DN-10L: tradename, manufactured by Daicel Chemical Industries, Ltd.).

Evaluation Test

The following evaluation tests were carried out for Examples 1 to 8 and Comparative Examples 1 and 2. The results were as described in Table 1 below.

Evaluation 1: Liquid Crystal Alignment Evaluation Test

The alignment of the liquid crystal face was judged based on the following criteria.

Evaluation Criteria

◯: Homogeneously aligned.

Δ: Partially heterogeneously aligned.

X: Heterogeneously aligned.

Evaluation 2: Evaluation Test on Adhesion Between Aligning Film and Optical Functional Layer

A cellophane tape was once adhered to and peeled off from the surface of the optical functional layer, and the results were evaluated according to the following criteria.

Evaluation Criteria

◯: Optical functional layer not separated.

Δ: Optical functional layer partially separated.

X: Optical functional layer entirely separated.

Evaluation 3: Moist Heat Resistance Evaluation Test

The optical element was allowed to stand under conditions of temperature 75° C. and humidity 95% for 100 hr. The results were evaluated according to the following criteria.

Evaluation Criteria

◯: Homogeneous liquid crystal alignment with freedom from separation of each layer.

Δ: Partially heterogeneous liquid crystal alignment with slight separation of each layer.

X: Heterogeneous liquid crystal alignment with separation of each layer.

TABLE 1

| Example/evaluation | Evaluation 1 | Evaluation 2 | Evaluation 3 |
|---|---|---|---|
| Ex. 1 | ◯ | ◯ | — |
| Ex. 2 | ◯ | Δ | — |
| Ex. 3 | ◯ | ◯ | — |
| Ex. 4 | ◯ | ◯ | — |
| Ex. 5 | ◯ | ◯ | Δ |
| Ex. 6 | ◯ | ◯ | ◯ |
| Ex. 7 | ◯ | ◯ | Δ |
| Ex. 8 | ◯ | ◯ | ◯ |
| Comp. Ex. 1 | ◯ | X | X |
| Comp. Ex. 2 | ◯ | X | — |

1. A process for producing an optical element comprising a plastic support and, provided on said plastic support in the following order, an aligning film, and at least one optical functional layer containing a liquid crystalline compound, said process comprising the steps of:
forming, on the surface of said plastic support, said aligning film using a composition comprising:
(A) a nonionic water-soluble etherified polysaccharide; and
(B) water, or a lower alcohol solvent, or both; and
forming said optical functional layer on the surface of said aligning film.

2. A process for producing an optical element comprising a plastic support and, provided on said plastic support in the following order, an aligning film, and at least one optical functional layer containing a liquid crystalline compound, said process comprising the steps of:
forming, on the surface of said plastic support, said aligning film using a composition comprising:
(A) a nonionic water-soluble etherified polysaccharide selected from hydroxyethylcellulose, hydroxypropylmethylcellulose, methylcellulose, or a combination thereof; and
(B) water, or a lower alcohol solvent, or both; and
forming said optical functional layer on the surface of said aligning film.

3. A process for producing an optical element comprising a plastic support and, provided on said plastic support in the following order, an aligning film, and at least one optical functional layer containing a liquid crystalline compound, said process comprising the steps of:
forming, on the surface of said plastic support, said aligning film using a composition comprising:
(A) a water-soluble polysaccharide;
(B) water, or a lower alcohol solvent, or both; and
(C) a monomer or oligomer having an ethylenically unsaturated bond; and
forming said optical functional layer on the surface of said aligning film.

4. The process according to any one of claims 1-3, wherein said liquid crystalline compound is a mixture of a polymerizable nematic liquid crystal or a polymerizable nematic liquid crystal with a polymerizable chiral agent.

5. The process according to any one of claims 1-3, wherein said plastic support is a cellulose ester film.

6. The process according to claim 5, wherein said cellulose ester film has been saponified.
